(19) United States
(12) Patent Application Publication
(10) Pub. No.: US 2010/0305988 A1
(43) Pub. Date: Dec. 2, 2010

(54) Enhancing Quality of Contact Lists for Direct Marketing Campaigns

(75) Inventors: Nishant AGARWAL, Gurgaon (IN); Rajesh Chopra, Gurgaon (IN); Sharat Rapur, Gurgaon (IN)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 12/471,941

(22) Filed: May 26, 2009

(51) Int. Cl. G06Q 10/00; G06F 17/30; G06Q 30/00

(52) U.S. Cl. 705/7; 707/E17.044

(57) ABSTRACT

A method, system, and computer program product are used for enhancing quality of contact lists for direct marketing campaigns. An embodiment of the method includes receiving a contact list that includes a plurality of customer profiles, and performing at least one of a counts verification check, a criteria outlier check, a data values check, and an output file check on the contact list. The method performs the aforementioned checks based at least partially on one or more quality check (QC) parameters. Further, the method includes generating a QC report that includes error statistics pertaining to at least one of the aforementioned checks. The method further generates an exceptions report based on the QC report and the QC parameters, and modifies the QC parameters based on the exceptions report.

### BACKGROUND

1. Field

Embodiments of the invention relate generally to marketing campaigns and more specifically to systems, methods and computer program product to perform quality checks on contact lists for direct marketing campaigns.

2. Background

In a direct marketing campaign, a contact list identifies the target customers to be contacted for the campaign. In various known solutions, a Campaign Management System (CMS) generates such a contact list from a list of customer profiles. More specifically, the CMS filters the list of customer profiles based on campaign criteria as well as the privacy preferences of customers to arrive at a desirable contact list for the campaign. The customer profiles include customer-specific information, such as contact information, financial information, demographic information, personal information, and privacy preferences for the customers. For example, the customer profile may have data fields such as the name, email address, account number, telephone number, postal address, country of residence, and the age of the customer.

It is common for customer profiles to be aggregated from multiple upstream sources, such as commercial databases that offer such information for sale and company databases that store such information for existing customers of a company. The CMS often does not have any control over the quality of the customer profiles available from upstream sources, and it is common for data fields in the customer profiles to have invalid entries and/or format inconsistencies. However, the CMS performs automatic filtering of the list of customer profiles based on the campaign criteria and the privacy preferences of the customers. Thus, the errors and inconsistencies in the customer profiles may cause the CMS to incorrectly apply the campaign criteria and/or privacy preferences to the list of customer profiles, and thereby generate a contact list that does not conform to the desired campaign criteria and customer privacy preferences.

The erroneous entries in the contact list may result in contacting a customer who has set his/her privacy preferences to opt out such direct marketing campaigns. In some instances, the privacy preferences are very critical and their violation in the direct marketing campaigns may result in lawsuits against a marketer, which may lead to financial and market losses.

Furthermore, the contact list is used by a campaign delivery system, such as a mass-mailer program for email campaigns, a call center for a telephone campaign, or a logistics provider for a direct mail campaign. Therefore, errors and inconsistencies in the customer profile data may lead to incorrect delivery of the campaign messages. This leads to a waste of resources for the marketer leading to financial losses, and may additionally erode the customer's desire to participate in a marketing campaign. For example, in a direct mail marketing campaign, any erroneous entries in the customer address field of the contact list may lead to loss of resources if the potential customers do not receive the marketing campaign.

To avoid the aforementioned issues, the marketer should perform quality checks (QCs) on the contact list generated for the campaign. Currently, these quality checks may be performed manually, if they are performed at all. Skilled personnel check for any error or data inconsistencies, which may be present in the contact list generated for the campaign. The skilled personnel also check the campaign criteria and ensure that the privacy preferences are properly followed. However, the manual quality checks require considerable time and effort on the part of the skilled personnel. Moreover, this approach is prone to human errors.

Therefore, there is need for a more efficient, accurate, and inexpensive means to perform quality checks (QC) on contact lists for the marketing campaigns.

### BRIEF SUMMARY

A method, system and computer program product for performing QC automatically on a contact list for a direct marketing campaign are provided.

In an embodiment, there is provided a method for performing quality checks (QC) on a contact list for a direct marketing campaign. The method includes receiving the contact list. The contact list includes a plurality of customer profiles. The method further includes performing at least one of a counts verification check, a criteria outlier check, a data values check, and an output file check on the contact list based on QC parameters. The method further includes generating a QC report. The QC report includes error statistics pertaining to at least one check performed on the contact list. The method further includes generating an exceptions report based on the QC report and the QC parameters. The method further includes modifying the one or more QC parameters based on the exceptions report.

In another embodiment, there is provided a system for performing quality checks (QC) on a contact list for a direct marketing campaign. The system includes a QC module, which receives the contact list. The contact list includes customer profiles. The QC module performs a counts verification check, a criteria outlier check, a data values check, and an output file check on the contact list based on QC parameters. The QC module generates a QC report. The QC report includes error statistics pertaining to at least one check performed on the contact list. The QC module generates an exceptions report based on the QC report and the QC parameters. The QC module modifies the one or more QC parameters based on the exceptions report.

In another embodiment, there is provided a computer program product including a computer useable medium having a computer program logic recorded thereon for controlling at least one processor, wherein the computer program logic includes computer program code devices that perform operations similar to the above mentioned method and system embodiments.

Further features and advantages of the present invention as well as the structure and operation of various embodiments of the present invention are described in detail below with reference to the accompanying drawings.

### BRIEF DESCRIPTION OF DRAWINGS

The features and advantages of the present invention will become more apparent from the detailed description set forth below when taken in conjunction with the drawings. The left-most digit of a reference number identifies the drawing in which the reference number first appears.

FIG. 1 is a system diagram of an exemplary framework, in accordance with an embodiment of the present invention;

FIG. 2 is a flowchart of an example process for performing QC, in accordance with an embodiment of the present invention;

FIG. 3 is an illustration of data flow and processing based on the one or more checks, in accordance with various embodiments of the present invention;

FIGS. 4-8 are tables showing exemplary counts of the number of customers during the application of campaign criteria and privacy preferences against a sample consumer population, in accordance with various embodiments of the present invention;

FIG. 9 shows an exemplary view of the QC parameters that can be defined for performing the one or more checks, in accordance with various embodiments of the present invention;

FIGS. 10-12 are tables showing exemplary results and outputs of the process in the FIG. 2 against a sample consumer population, in accordance with an embodiment of the present invention; and

FIG. 13 is a block diagram of an exemplary computer system for implementing the present invention, in accordance with an illustrative embodiment of the present invention.

Embodiments of the invention will be described with reference to the accompanying drawings. The drawing in which an element first appears is typically indicated by the leftmost digit(s) in the corresponding reference number.

### DETAILED DESCRIPTION

### I. Overview

Embodiments of the present invention are directed to a method, system, and computer program product for automatically performing quality checks (QC) on a contact list. The contact list includes multiple customer profiles. One or more checks are performed automatically on the contact list based at least partially on one or more QC parameters. The contact list that passes the one or more checks may be sent to delivery teams or a marketer for delivering the direct marketing campaign.

The system, method, and computer program product are described herein in the context of direct marketing campaigns, and in an embodiment implemented in the context of financial services businesses. The terms “business”, “merchant”, “organization”, and/or “enterprise” may be used interchangeably with each other and shall mean any person, entity, distributor system, software and/or hardware that is a provider, a third-party service provider and/or any other entity in the distribution chain of goods or services.

It should specifically be understood that the system, method, and computer program product could as well be implemented and applied in contexts other than or in addition to business contexts. For example, the system, method, and computer program product described herein could be implemented by non-profit organizations, not-for-profit organizations, governmental and quasi-governmental organizations, professional organizations, religious organizations, educational institutions, civic organizations, and/or any other organizations which maintain and manage customer or client information, which offer any kind of service or product to customers or clients, or which interact in other ways with customers or clients.

It shall be understood that the terms “customer profile”, “record”, “contact list”, “list of customers”, “customer list”, and similar terms and phrases used throughout the document may be used interchangeably with each other and shall mean a customer profile or a list of customer profiles as defined in the specification.

It shall be further understood that terms such as “marketing activity”, “marketing process”, “marketing campaign”, “direct marketing campaign”, “campaign”, “promotion”, and similar terms and phrases used throughout this document refer not only to marketing activity as conventionally understood, e.g., the offer or promotion of products or services to customers, but shall further include, without limitation, the sharing or distribution of customer information within a business or business unit, or with affiliated businesses or organizations.

The present invention is now described in more detail herein in terms of the above exemplary business context, and typically in the context of a financial business. This is for convenience only and is not intended to limit the application of the present invention. In fact, after reading the following description, it will be apparent to one skilled in the relevant art(s) how to implement the following invention in alternative embodiments, as indicated above. Thus, the description provided below is for purposes of illustration and explanation only, and should not be construed as limiting the scope of the invention. Rather, the scope of the present invention is determined by the appended claims.

### II. Description of Invention

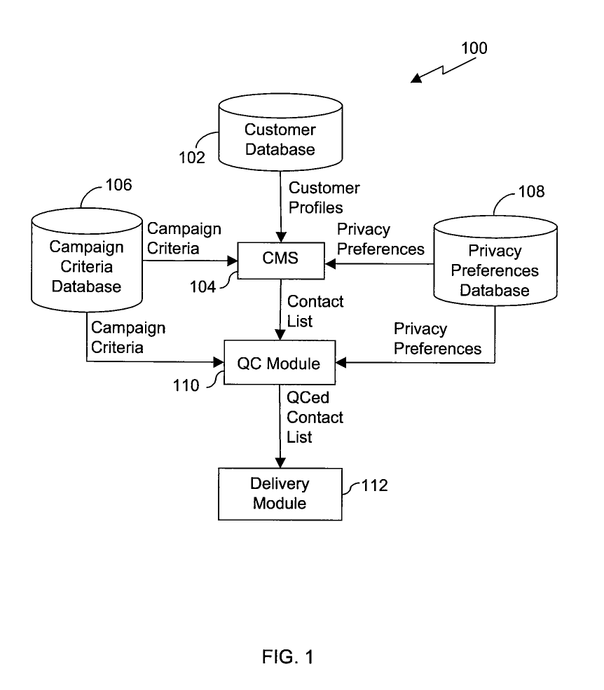

FIG. 1 is a system diagram 100 of an exemplary framework, in accordance with an embodiment of the present invention. The system 100 shows a customer database 102 storing customer profiles available for consideration for a direct marketing campaign. The system 100 further shows a campaign management system (CMS) 104 for filtering the customer profiles in the customer database 102 based on campaign criteria as well as the privacy preferences of customers to generate a contact list for a campaign. The CMS 104 obtains campaign criteria from a campaign criteria database 106, and obtains the privacy preferences from a privacy preferences database 108. The contact list generated by the CMS 104 is further fed to a QC module 110 for performing quality checks on the contact list. The QC module 110 verifies whether the contact list conforms to the campaign criteria and to the privacy preferences of the customers. In various embodiments, the QC module 110 further checks the data fields of the customer profiles in the contact list for missing or misaligned values, and layout of the contact list.

The customer database 102 includes a plurality of customer profiles related to the business. The customer profiles include customer-specific data in a plurality of data fields such as, but not limited to, customer name, location, age, gender, postal address, e-mail address, credit/debit card number, and monthly spend of the customer. The customer profiles, including the customer-specific data, are fetched from different upstream sources such as, for example, the Global New Accounts (GNA) database, the Globe Star (GSTR) database, and the Global Risk Management System (GRMS) database. In an embodiment, the customer profiles are aggregated from multiple upstream sources and stored in the customer database 102 for use by the CMS 104. The CMS 104 also incorporates the privacy preferences of the customers, stored in the privacy preferences database 108, in generating the contact list.

The privacy preferences database 108 stores privacy preferences of one or more customers. The privacy preferences of a customer are representative of the customer's acceptance to be contacted in various direct marketing campaigns. For example, the customer may agree to receive email campaigns, but opt out of telemarketing campaigns. In an embodiment, the privacy preferences database 104 includes a ‘Do Not Call’ list including customers that should not be contacted for a telemarketing campaign, and a ‘Do Not Email’ list including customers that should not be contacted for an email campaign. Further, the customer may choose to only receive direct marketing campaign communication related to his/her interests. For example, the customer may opt to receive campaign communication related to shopping discounts, and not receive campaign communication related to travel deals. A person skilled in the art will recognize the privacy preferences database 108 may also include other privacy preferences, such as, for example and without limitations, the kind of marketing material the customers would want to receive or the type of promotional offer the customers would not like to receive.

The campaign criteria database 106 includes one or more campaign criteria for every direct marketing campaign that define parameters building a basis for the selection and exclusion of customers from the direct marketing campaign. The campaign criteria may be chosen on the basis of the direct marketing campaign for selecting or suppressing customers. For example, consider an email marketing campaign for providing cash-back offers to credit card customers. The campaign criteria may specify the geographic location of markets where the cash-back offer campaign will be launched, the credit card type of the customers to whom the email marketing campaign is targeted, and one or more criteria for the customers to be eligible for the cash-back offer campaign, such as a threshold on the average spend of the customer. In an exemplary case, the cash-back offer campaign may be targeted to the customers residing in the United Kingdom (UK), having a Gold or Platinum credit card and who on an average spend more than GBP 5000 per month. The campaign criteria may also specify the type of marketing campaign such as email marketing or a telemarketing campaign for the CMS 104, thereby excluding customers whose required contact details for a given campaign type are not on the record. The above mentioned campaign contents are described only for exemplary purposes and a person skilled in the art will appreciate that different criteria such as, without limitations, gender, age, credit history, education, profession, interests and the like may be specified in various campaign criteria.

The CMS 104 generates the contact list based on different criteria as per the requirements of the direct marketing campaign. In one embodiment, the CMS 104 may process and generate contact lists for multiple campaigns in parallel. The contact list includes a plurality of customer profiles that are eligible for receiving the direct marketing campaign. The CMS 104 accesses the customer profiles in the customer database 102. The CMS 104 further retrieves the campaign criteria for selecting and excluding customers and the privacy preferences of the customers from the campaign criteria database 106 and the privacy preferences database 108, respectively. The CMS 104 matches the customer profiles in a database with the campaign criteria to prepare a list of customers who are eligible for the direct marketing campaign. A person skilled in the art will recognize various techniques, without limitations, that may be used to match the campaign criteria with the customer profiles obtained form the customer database 102. The CMS 104 further applies the privacy preferences of the eligible customers for removing customers who cannot be contacted due to their privacy preferences settings. For example, in an email marketing campaign, the CMS 104 may use the ‘Do Not Email’ list to remove those customers who do not wish to be contacted via email. After application of the campaign criteria and the privacy preferences, the CMS 104 prepares the contact list including a plurality of customer profiles containing data of the customers that are eligible for the direct marketing campaign and can be contacted as per their privacy preferences. The CMS 104 then sends the contact list to the QC Module 110.

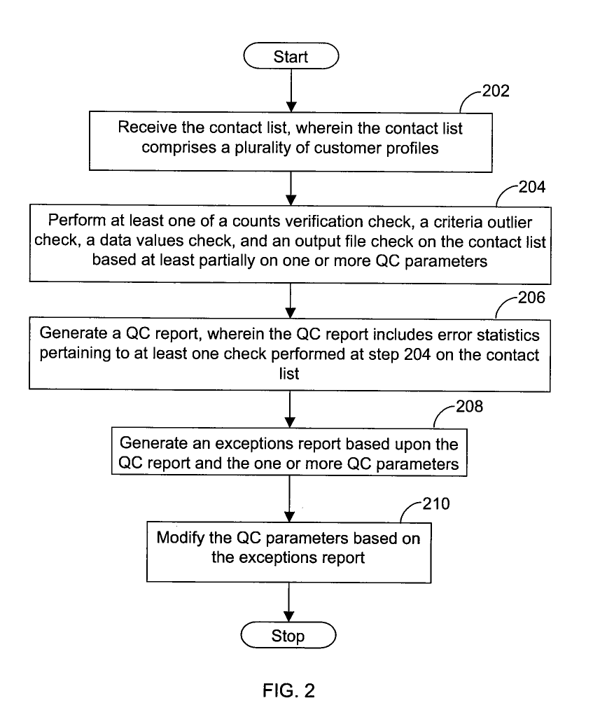

The QC module 110 automatically performs one or more checks in the contact list including, without limitation, a counts verification check, a criteria outlier check, a data values check, and an output file check for assessing the quality of the contact list. The data values check and the output file check are based on one or more QC parameters, which are explained in detail in conjunction with FIG. 2. The QC module 110 retrieves the campaign criteria from the campaign criteria database 106 for the direct marketing campaign and the privacy preferences of the customers from the privacy preferences database 108. In an embodiment of the invention, the QC module 110 uses the campaign criteria and the privacy preferences to perform the criteria outlier check and the counts verification check. If a contact list passes the one or more checks, a QC report is delivered to a delivery module 112. In one embodiment, the QC module 110 may be deployed by a marketer launching the direct marketing campaign. In another embodiment, the QC module 110 may be deployed by a third-party service provider.

The delivery module 112 receives the QC report from the QC module 110, and delivers the direct marketing campaign to the customers on the QCed contact list. In an embodiment, the delivery module 112 may include software for delivering campaign materials such as ‘Tumbleweed Secure CRM’ provided by Tumbleweed® Communications Corp. for delivering the direct marketing campaigns online via emails. In another embodiment, the delivery module 112 may be an interface with a human team such as a call center or a logistics solution provider for delivery of telemarketing campaigns and direct mail campaigns respectively. It will be apparent to one skilled in the art that a variety of different campaign delivery mediums may be used in conjunction with the present invention, and the delivery module 112 may include various combinations of software as well as manual processes within the marketer's organization and with external vendors without deviating from the spirit and scope of the present invention.

FIG. 2 is a flowchart of an example process for performing quality checks, in accordance with an embodiment of the present invention. At step 202, the QC module 110 receives the contact list for QC. The contact list includes a plurality of customer profiles corresponding to customers selected by the CMS 104 for the direct marketing campaign. Each customer profile includes multiple data fields representing the customers' data, for example, customer name, e-mail address, telephone number, age, location, postal address, gender code and so on.

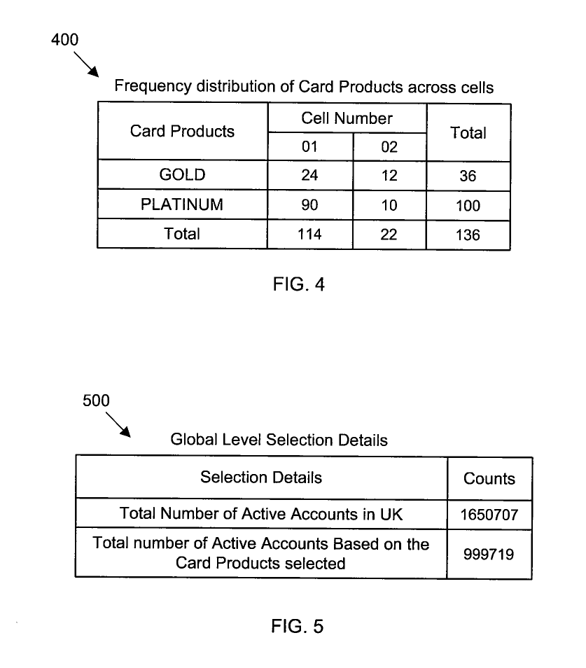

At step 204, one or more checks are performed automatically by the QC module 110, for assessing the quality of the contact list. The checks include a counts verification check, a criteria outlier check, a data values check and an output file check. The counts verification check includes checking the file counts at different stages of processing during the application of the campaign criteria and the privacy preferences of the customers. For example, the counts verification check can occur after application of campaign criteria, after application of privacy preferences, after creation of final files, etc. File counts include number of customers in the contact lists to be targeted for the marketing campaign. An exemplary illustration of file counts for different campaign criteria and suppressions is provided below in conjunction with tables in FIGS. 4-8. The criteria outlier check is performed for checking proper application of the campaign criteria as per the direct marketing campaign and the privacy preferences for the customer profiles in the contact list. The criteria outlier check ensures that the customers who had opted-out of the direct marketing campaigns are not present in the contact list. If present, they are reported in the exception report and the system fails quality check for that campaign. Further, the output file check is performed for checking the layout of the output file and verifying the file counts. The layout of the output file may be checked based on the QC parameters defined for the respective direct marketing campaign. For example, the contact list may have a pre-defined format for an email marketing campaign. The output file check is performed for verifying whether the layout of the contact list conforms to the pre-defined layout.

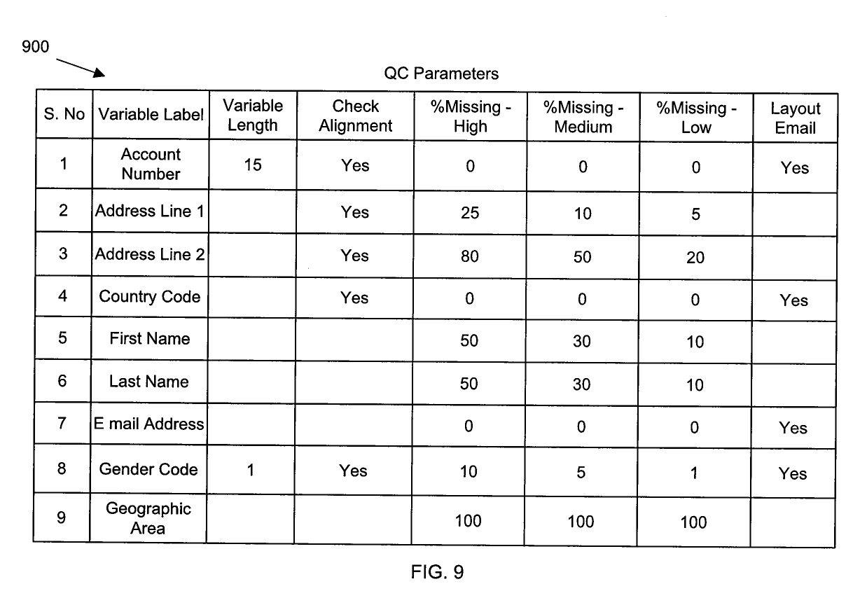

Further, the data values check is carried out based on the QC parameters. The QC parameters include a set of thresholds for the percentage of missing/misaligned values in a particular data field, and the layout of the data fields and the output file for different types of output files. Some exemplary QC parameters are discussed in conjunction with FIG. 9. The QC parameters may have more than one threshold. The third (lower) threshold defines a maximum acceptable percentage of missing values for a particular data field. If the percentage of missing values exceeds the third threshold, result of the automatic QC for that particular data field is ‘FAIL’. For example, if the third threshold for the percentage of missing values in a data field “TELEPHONE NUMBER” corresponding to telephone number of a customer is 20%, then the automatic QC will report a failure for the data field “TELEPHONE NUMBER” when more than 20% of telephone numbers are missing in the contact list. Similarly, the data field “TELEPHONE NUMBER” will pass the automatic QC if the percentage of missing telephone numbers is less than 20%. The lower threshold may be same for all data fields in the customer profiles in the contact list. Alternatively, it may be different for two or more data fields in the customer profiles in the contact list; for example, the data fields named “ACCOUNT NUMBER” and “E-MAIL ADDRESS” may have different thresholds for the percentage of missing values in the customer profiles in the contact list. The customer profiles in the contact list are checked for the data values in each data field for all the customers.

In one embodiment, the thresholds for different data fields may be set independently depending upon the direct marketing campaign. For example, for an email marketing campaign email address of the customers is one of the most critical data fields for the campaign's success, while the availability of telephone numbers may not be as important. In this case, the lower thresholds for the data field “E-MAIL ADDRESS” may be set lower, for example, about 10%, than for the data field “TELEPHONE NUMBER” field, for example, about 80%.

In one embodiment, the QC parameters may be defined for each direct marketing campaign separately. In another embodiment, two or more direct marketing campaigns may share same QC parameters.

The QC parameters also contain thresholds for the percentage of misaligned values in the data fields in the customer profiles in the contact lists. For example, the credit card number may have a specific column number defined from where it should start, and if the number does not start from its specified column number then it is considered as misaligned. If the percentage of misaligned values crosses the thresholds set for that particular data field, in this case the credit card number, the contact list fails QC for that field. In an embodiment, the data fields may have multiple thresholds with a level of severity for the percentage of missing values or misaligned values. For example, for e-mail address data field, the thresholds can be set as first threshold (30%—high), second threshold (10%—medium), third threshold (1%—low), which would indicate that if the percentage of missing values are less than third threshold, it may show no error or severity and the contact list may ‘PASS’ the checks, if the percentage of missing values are between second and third threshold then it may fail the QC and show as low severity, if the percentage of missing values are between first and second threshold it will fail the QC and show medium severity and if the percentage of missing values are greater than first threshold then it may show high severity and the contact list may fail the quality checks.

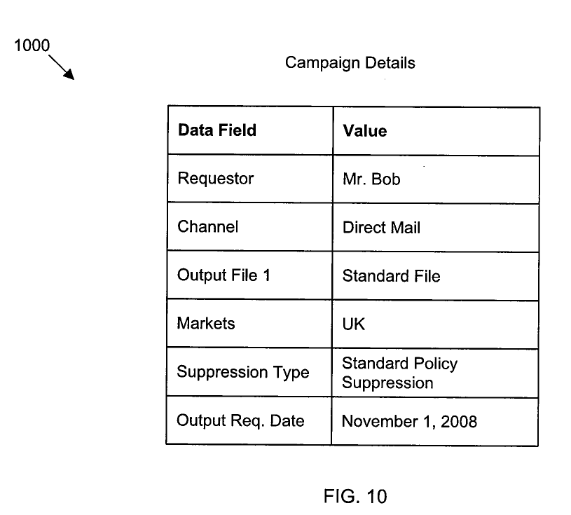

Thereafter, at step 206, a QC report is generated which includes results of the checks performed on the contact list. The results include error statistics pertaining to the checks that are performed on the contact list. An exemplary illustration of results of the checks as reported in the QC report is explained in conjunction with tables in FIGS. 10-12. The QC report may include error statistics of the automatic QC performed on the contact list.

In an embodiment, personnel may review the criticalities reported in the QC report to know the reason of failures of the quality check. The personnel can manually override the checks and ‘PASS’ the checks for one or more data fields, if required. An exceptions report is generated which includes the manually passed data fields in the contact list. At step 210, the QC parameters may be modified based on the generated exceptions report. The QC parameters may be manually changed based on the exception report. In an exemplary case, at least one of the thresholds is modified. The modified QC parameters may be fed again in step 204 for performing the checks for future direct marketing campaigns. This improves accuracy of the automatic QC and makes it more efficient and robust. For example, in a telemarketing campaign if 9% of the values in the data field ‘TELEPHONE NUMBER’ are missing and in the QC parameters the failure threshold for the data field ‘TELEPHONE NUMBER’ was set at 5%, then the quality check will ‘FAIL’ the contact list. Further, if multiple campaigns have close to 9% values in the ‘TELEPHONE NUMBER’ data field missing, then the marketer may choose to accept such a failure rate for the particular data field if, for example, the data field is desirable but not critical for the administration of the direct marketing campaign. The marketer could then update the high severity failure threshold for this data field from 5% to 10%. Thus, for future quality checks the QC module 110 will pass the contact lists that have around 9% missing values in ‘TELEPHONE NUMBER’.

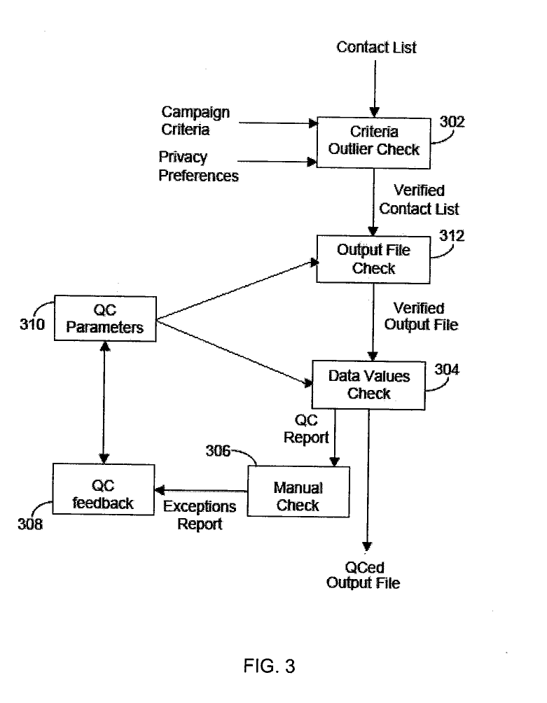

FIG. 3 is an illustration of data flow and processing based on the one or more checks, in accordance with various embodiments of the present invention. At block 302, the criteria outlier check is performed on the contact list. The criteria outlier check includes verifying the application of campaign criteria and the privacy preferences. The customer profiles in the contact list are verified for the application of suppressions based on the campaign criteria.

The contact list is also checked for the proper application of the privacy preferences of the customers. If discrepancies are found in the contact list based on the criteria outlier check, the contact list will FAIL the QC.

After the criteria outlier check, the verified contact list undergoes an output file check at block 312. The output file check is carried out for checking the layout of the contact list. The contact list may be created in different layouts and the data fields for which the layout has to be checked may be specified in the QC parameters. After passing the output file check, a data values check is performed at block 304. The customer profiles, in the verified contact list, including a number of data entries corresponding to plurality of data fields with customers' data such as customer name, age, address, email id, telephone number and the like, are checked for the data values based on the one or more QC parameters. The QC parameters may be defined based on the type or kind of the direct marketing campaign.

The data values check may also include checking for misaligned values in the data fields. The QC parameters may define beginning locations for some of the data fields and any of those fields that do not start from the specified locations are termed misaligned and the QC fails for those data fields.

The results of the criteria outlier check, output file check, and data values check are reported in the QC report. The QC report includes the results of the data values check for all the data fields for all the customers in the contact list. The data fields that have failed the data values check are specified in the QC report. In an embodiment of the invention, at block 306, personnel may manually review the QC report and further override the results. The exceptions that are manually overridden are reported in an exception report. The exception report may be used for QC feedback at block 308 for improving the accuracy of the data values checks by altering the QC parameters at block 310. The thresholds for the percentage of missing values for all or any of the data fields may be changed based on the exceptions reported in the exceptions report.

When the contact list passes the criteria outlier check, the data values check, and the output file check, the QCed contact list may be sent to delivery teams.

Although FIG. 3 shows the one or more checks performed in an order, it should be understood by a person skilled in the art that the one or more checks may be performed in any order without departing from the spirit and scope of the present invention.

The process by which the CMS 104 generates the contact list, in accordance with various embodiments of the present invention, is hereinafter described in conjunction with FIGS. 4-8.

FIGS. 4-8 are tables showing exemplary counts of the number of customers during the application of exemplary campaign criteria and privacy preferences against a sample consumer population, in accordance with various embodiments of the present invention. Different counts are based on different parameters presented in the FIGS. 4-8, which were analyzed for generating the contact list for the direct marketing campaign based on various campaign criteria, as discussed earlier in step 202 in FIG. 2. The tables are for illustrative purposes only and it should be understood by a person skilled in the art that the tables will differ from implementation to implementation depending on factors such as, but not limited to, the markets chosen, number of customers or the campaign criteria. Targeted customers of the direct marketing campaign may be segmented into cells based on different parameters. In one case, the cell segmentation may be based on gender code so that targeted male customers are assigned to “Cell Number 01” while targeted female customers are assigned to “Cell Number 02”. A person skilled in the art will appreciate that although only two cells are shown in the table 400, it should be apparent that embodiments of the present invention may employ any number of cells depending on the type of segmentation. The cell segmentation may be done based upon other parameters such as, but not limited to, age group, annual spend, geographical location and the like.

FIG. 4 shows an exemplary table 400 depicting the distribution of customers for card products selected across multiple cells for an exemplary campaign, in accordance with one embodiment. The table 400 shows two card products, namely, GOLD and PLATINUM and corresponding count of customers within each cell. Although only 2 card products are selected it will be understood by a person skilled in the art that the number of card products shown in the tables is only for exemplary purposes and any number of card products may be selected depending on the type of the direct marketing campaigns.

Further, in FIG. 5-8, the tables show global and cell level selection/suppression details based on various campaign criteria and other criteria such as customized selection/suppression criteria as per the type of direct marketing campaign. As discussed earlier, the customers are selected or suppressed as per the customer details and the campaign criteria.

The table 500 of FIG. 5 shows overall selection details for an exemplary UK market. The table 500 shows the total number of accounts that are active in UK and the number of customers selected based on the card products selected for the direct marketing campaign. The card products selected are for illustrative purposes only and depending on the direct marketing campaigns, various other criteria can be used for selection of customers.

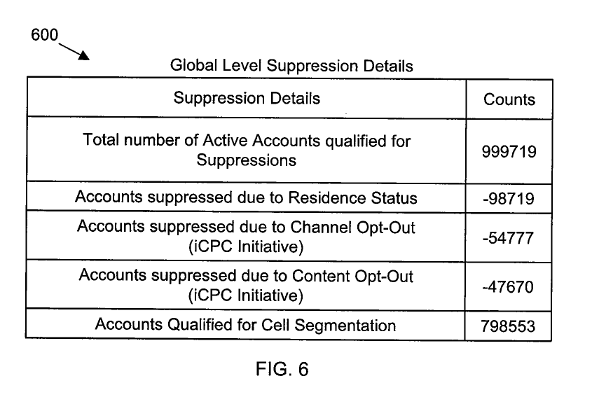

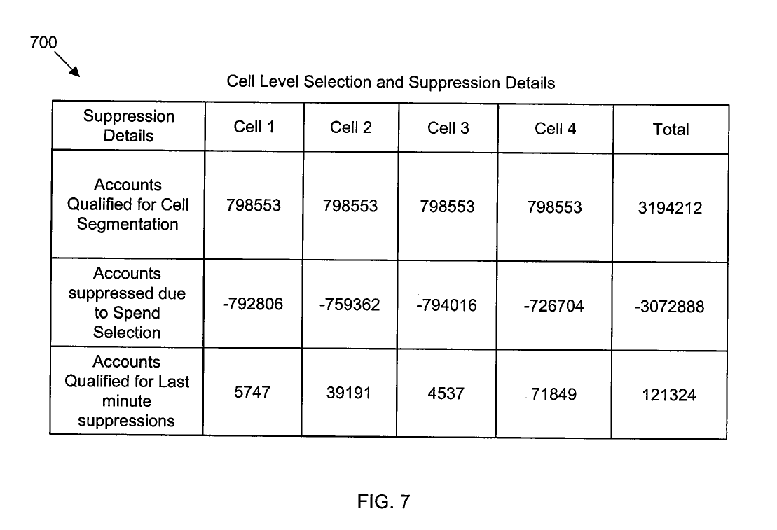

The table 600 of FIG. 6 illustrates the various suppression criteria, which may be applied on the customers according to the campaign criteria or other criteria for the direct marketing campaign. The suppression criteria applied in the table 600 are Residence Status, Channel Opt-Out and Content Opt-Out. It should be noted further that these suppression criteria are for illustrative purposes only and various other criteria such as but not limited to, ‘UK Sub-Prime’ suppressions, and ‘60 days past due’ suppressions may be applied for suppression of customers. After application of various suppression criteria, accounts that qualify are selected for further suppressions on the cell level as described with reference to FIG. 7.

The table 700 of FIG. 7 illustrates the cell level selection/suppression details of the qualified accounts. The table 700 shows the suppression due to a spend selection criteria. The spend selection criteria may be, for example, to select customers who spend more than GBP 5000 within a selected period, such as a particular month. The accounts are segmented in cells which, in one embodiment, may correspond to the spending limit of the customer. In this example, “Cell Number 1” includes customers with spending limits between GBP 5001 and 6000, and “Cell Number 2” includes customers with spending limits between GBP 6001 and 7000. The accounts segmented in the cells are then suppressed respectively as per the spend selection criteria and the accounts that qualify (shown in the figure in the row marked ‘A/C Q4 LMS’) are processed for final selection/suppression.

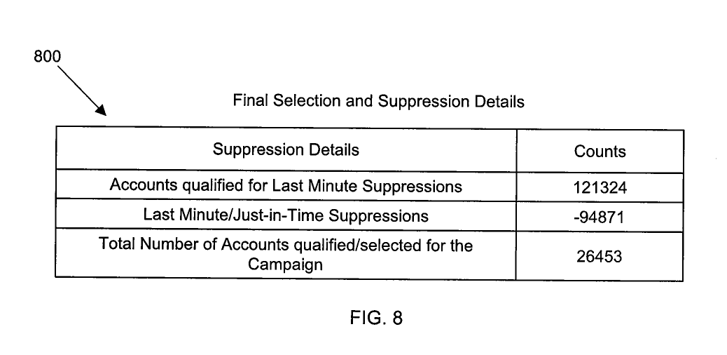

The table 800 of FIG. 8 illustrates the final selection/suppression details for the accounts that have qualified through all the above suppression criteria. These accounts are subjected to criteria such as but not limited to Last Minute/Just-in-Time Suppressions. In an embodiment, a Last Minute/Just-in-Time Suppression is implemented as follows. The CMS pulls data from various historical data sources that are refreshed on a periodic basis (e.g., daily, weekly, monthly). Processing of a campaign may take, for example, 1-12 hours depending on the size of the market and selection/suppression criteria selected. In this process, privacy preferences applied to the list may not remain current at the end of execution. So, after all the processing, before writing out the final files, the CMS passes the list through a process in which most recent privacy preferences are applied to the cardmember list and most recent contact information (e.g., name, address, contact numbers, email addresses) is added to the cardmember list. In this process, some card members are suppressed due to changed privacy preferences or cancelled cards that may be indicated in the QC report as Last Minute/Just-in-Time suppressions. The drop here will typically not be very high, and the QC module may be set to fail the check if the drop is more than a given amount, for example 2%.

Finally, the accounts that qualify through these suppressions are selected and the contact list is prepared for the campaign.

The prepared contact list is then sent to the QC module 110 for automatic QC to check the application of various campaign criteria, privacy preferences and other checks such as the counts verification check, the criteria outlier check, the data values check and the output file check. The one or more of the above checks may be based on the QC parameters, which are described in detail below in conjunction with table 900 in FIG. 9. After, the automatic QC is performed on the contact list a QC report is generated which includes all the details of the checks performed on the contact list.

The table 900 of FIG. 9 shows an exemplary view of the QC parameters that can be defined for performing the one or more checks. The QC parameters define the basic criteria for one or more checks such as the data values check which is performed on the contact list. The table 900 includes a plurality of variables, which have to be checked in the contact list. The entries in the ‘Variable Label’ data field column shown in the table 900 are for illustrative purposes only and it will be apparent to a person skilled in the art that the ‘Variable Label’ data field may include various other variables such as, but not limited to, Product Code, Postal Code, Middle Name, Language Preference, etc. The table 900 also includes other columns namely, ‘Variable Length’, ‘Check Alignment’, ‘Percentage Missing—High’, ‘Percentage Missing—Medium’, ‘Percentage Missing—Low’ and ‘Layout Email’. The ‘Variable Length’ column defines the length of the variable stored in the data field, for example the ‘Account Number’ should, in an embodiment, have the length of 15 characters. The ‘Check Alignment’ column denotes the fields that have to be checked for alignment in the contact list. For example, the ‘Account Number’, ‘Address Line 1’, ‘Address Line 2’, ‘Country Code’, and ‘Gender Code’ will be checked for alignment as shown in the exemplary table 900.

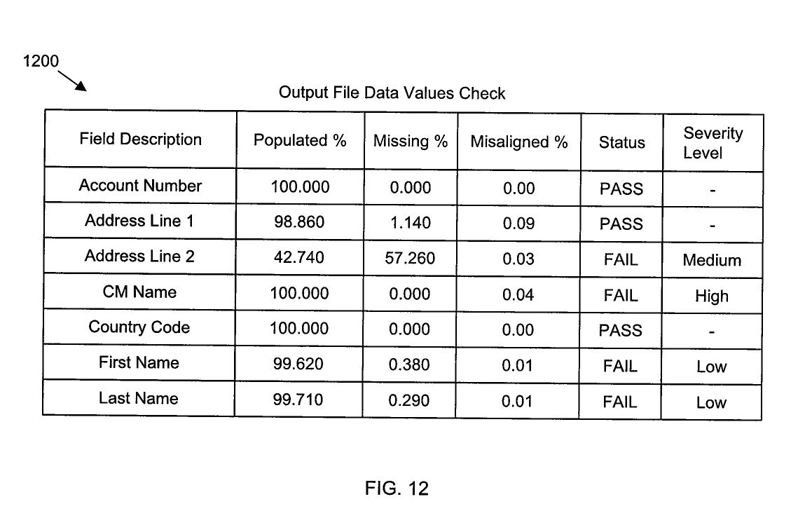

Embodiments of the present invention perform alignment checks for variables that have ‘Yes’ marked in the ‘Check Alignment’ column in the table 900. For example, the data field ‘Address Line 1’ is checked for alignment of the values for all the customers and the alignment errors are reported in the QC report as discussed further with reference to FIG. 12.

The columns ‘Percentage Missing—High’, ‘Percentage Missing—Medium’ and ‘Percentage Missing—Low’ of the table 900 define the thresholds for various variables for which warning is issued if the values are missing in the data fields. For example, the ‘Address Line 1’ field has the ‘Percentage Missing—Low’ threshold of 5%. If the percentage values missing in the ‘Address Line 1’ field are less than 5%, then the automatic QC marks the status as ‘PASS’ in the results of data values checks as discussed in conjunction with FIG. 12. Similarly for ‘Address Line 1’ the high severity failure threshold, ‘Percentage Missing—High’ is set as 25 percent and the medium severity threshold, ‘Percentage Missing—Medium’ is set as 10 percent. Thus, if 10 percent of the records are missing ‘Address Line 1’ then the automatic QC marks the result of the ‘Address Line 1’ field as ‘FAIL’ with a Medium severity level.

The data fields with all the three thresholds set as zero signifies that if even one of the many values in that particular data field is missing then the QC will FAIL. The data fields with all thresholds set to 100% indicate that the presence or absence of entries in that particular data field will not affect the QC result and that data field will PASS the QC for all cases. The thresholds can be defined for other variables as needed and the automatic QC will check the data values populated in the customer profiles in the contact list for all the variables based on all the checks as per the QC parameters. The QC parameters may also include parameters for the output file check as discussed earlier in conjunction with FIG. 2. For example, the last column of table 900 shows ‘Layout Email’, which indicates the layout check, should be carried out on the contact list. Various other layout checks can also be performed, during the automatic QC process, on the contact list.

FIGS. 10-12 are tables showing exemplary results and outputs of the process in FIG. 2 against a sample consumer population, in accordance with an embodiment of the present invention. The table 1000 in FIG. 10 shows exemplary campaign details with various data fields for identifying the type of direct marketing campaign. The table 1000 includes a ‘Markets’ data field to identify the region or country for which the campaign is processed. It further includes a ‘Channel’ data field to identify the type of marketing campaign for example, a direct mailer or a telemarketing campaign. A ‘Suppression Type’ data field identifies whether the suppressions were Standard Policy suppressions or Customized suppressions. The table may further include other data fields such as ‘Requestor’ to identify the person who initiated the request for the quality check, and ‘Output Req. Date’ indicating the date on which the quality checks were performed.

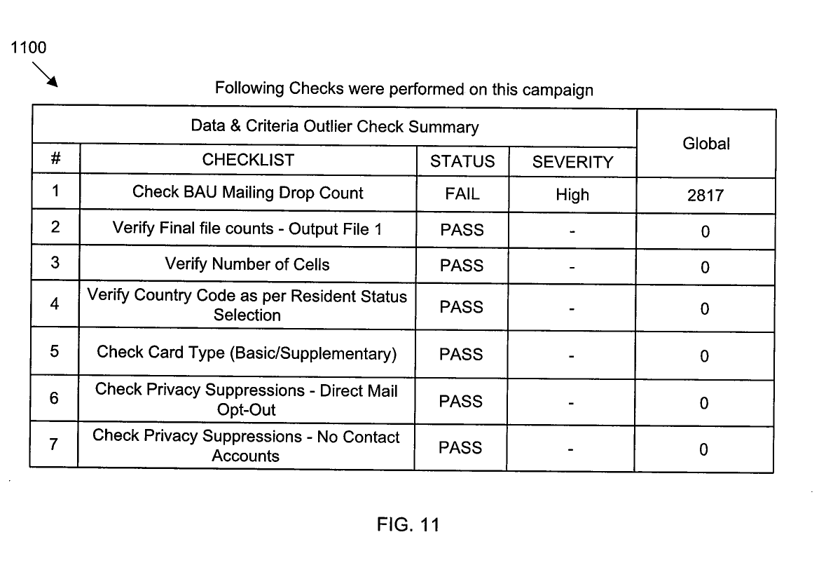

FIGS. 11-12 now show some exemplary tables of the QC report. The table 1100 of FIG. 11 illustrates a sample summary of the data value check and the Criteria Outlier Check performed on the contact list. The table 1100 also shows the status and the severity of the results obtained after the checks. The checks that fail the automatic QC, for example the ‘Business-As-Usual (BAU) Mailing Drop Count’ check, are marked with a ‘FAIL’ status and the severity is marked either ‘HIGH’, ‘MEDIUM’ or ‘LOW’ as per the QC parameters. The last column of the table 1100 shows the count of records that failed the check. For example, the table 1100 shows that 2817 records failed the ‘Check BAU Mailing Drop Count’ check. Other checks such as but not limited to ‘Card Type’, ‘Privacy Suppressions—Direct Mail Opt-Out’, ‘Privacy Suppressions—No Contact Accounts’ are also carried out on the contact lists and the results are shown in the table 1100.

The table 1200 of FIG. 12 shows an exemplary view of results of various data values checks and the output file checks. The table 1200 includes a plurality of data fields for which checks for the percentage of missing values and misaligned values were performed. The table 1200 lists the results of the checks performed for each of the data fields. The data fields shown in the table 1200 are for illustrative purposes only and the data consistency check can be performed on several other data fields such as but not limited to, ‘Business ID’, ‘Card Number (Basic or Supplementary)’, ‘Cell Number’, ‘Postal Code’, ‘Promo ID’, ‘Salutation’, ‘Service Center Code’ and so on. The status of the checks for the data fields is reported as ‘PASS’ or ‘FAIL’ in the column status of the table 1200. The column ‘Severity Level’ of the table 1200 includes the severity level of failure for the data fields that failed the quality checks. The severity level is decided based on the thresholds defined for the data field, as described in conjunction with the FIG. 9.

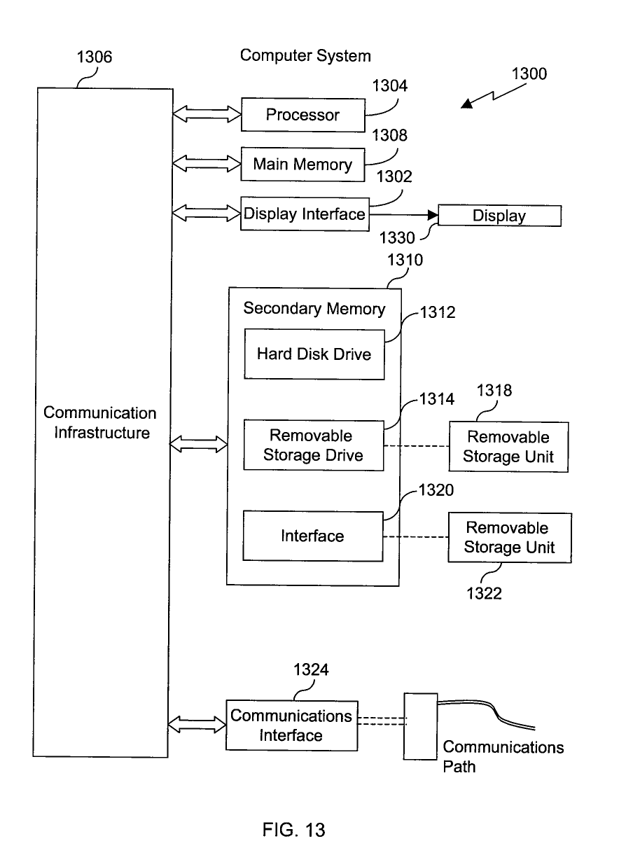

In fact, in one embodiment, the invention is directed toward one or more computer systems capable of carrying out the functionality described herein. An example of a computer system 1300 is shown in FIG. 13.

The computer system 1300 includes one or more processors, such as processor 1304. The processor 1304 is connected to a communication infrastructure 1306 (e.g., a communications bus, cross over bar, or network). Various software embodiments are described in terms of this exemplary computer system. After reading this description, it will become apparent to a person skilled in the relevant art(s) how to implement the invention using other computer systems and/or architectures.

Computer system 1300 can include a display interface 1302 that forwards graphics, text, and other data from the communication infrastructure 1306 (or from a frame buffer not shown) for display on the display unit 1330.

Computer system 1300 also includes a main memory 1308, preferably random access memory (RAM), and may also include a secondary memory 1310. The secondary memory 1310 may include, for example, a hard disk drive 1312 and/or a removable storage drive 1314, representing a floppy disk drive, a magnetic tape drive, an optical disk drive, etc. The removable storage drive 1314 reads from and/or writes to a removable storage unit 1318 in a well known manner. Removable storage unit 1318 represents a floppy disk, magnetic tape, optical disk, etc. which is read by and written to by removable storage drive 1314. As will be appreciated, the removable storage unit 1318 includes a computer usable storage medium having stored therein computer software and/or data.

In alternative embodiments, secondary memory 1310 may include other similar devices for allowing computer programs or other instructions to be loaded into computer system 1300. Such devices may include, for example, a removable storage unit 1322 and an interface 1320. Examples of such may include a program cartridge and cartridge interface (such as that found in video game devices), a removable memory chip (such as an erasable programmable read only memory (EPROM), or programmable read only memory (PROM)) and associated socket, and other removable storage units 1322 and interfaces 1320, which allow software and data to be transferred from the removable storage unit 1322 to computer system 1300.

Computer system 1300 may also include a communications interface 1324. Communications interface 1324 allows software and data to be transferred between computer system 1300 and external devices. Examples of communications interface 1324 may include a modem, a network interface (such as an Ethernet card), a communications port, a Personal Computer Memory Card International Association (PCMCIA) slot and card, etc. Software and data transferred via communications interface 1324 may be in the form of signals 1328 which may be electronic, electromagnetic, optical or other signals capable of being received by communications interface 1324. These signals 1328 are provided to communications interface 1324 via a communications path (e.g., channel) 1326. This channel 1326 carries signals 1328 and may be implemented using wire or cable, fiber optics, a telephone line, a cellular link, an radio frequency (RF) link and other communications channels.

In this document, the terms “computer program medium” and “computer readable medium” are used to generally refer to media such as removable storage drive 1314, a hard disk installed in hard disk drive 1312, and signals 1328. These computer program products provide software to computer system 1300. Embodiments of the invention is directed to such computer program products.

Computer programs (also referred to as “computer control logic”, “logic”, or “processing”, e.g., “CP&P processing”) are stored in main memory 1308 and/or secondary memory 1310. Computer programs may also be received via communications interface 1324. Such computer programs, when executed, enable the computer system 1300 to perform the features of the present invention, as discussed herein. In particular, the computer programs, when executed, enable the processor 1304 to perform the features of the present invention. Accordingly, such computer programs represent controllers of the computer system 1300.

In an embodiment where the invention is implemented using software, the software may be stored in a computer program product and loaded into computer system 1300 using removable storage drive 1314, hard drive 1312 or communications interface 1324. The control logic (software), when executed by the processor 1304, causes the processor 1304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

The foregoing specification recites a number of databases such as the customer database 102, the campaign criteria database 106, and the privacy preferences database 108. It will be apparent to one skilled in the art that a variety of database types, database designs, formats and configurations may be employed to implement the customer database 102 without deviating from the spirit and scope of the present invention. For example, two or more of the aforementioned databases may be implemented as a single federated database system or virtual database. Further, in various embodiments, the data attributed to two or more databases in the foregoing specification may be stored in a single physical database or a single virtual database.

While various embodiments of the present invention have been described above, it should be understood that they have been presented by way of example, and not limitation. It will be apparent to persons skilled in the art that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of performing quality checks (QCs) on a contact list for a direct marketing campaign, the method comprising;
a. receiving the contact list from a campaign management system, wherein the contact list comprises a plurality of customer profiles;
b. electronically performing, using a QC system, at least one of a counts verification check, a criteria outlier check, a data values check, and an output file check on the contact list based at least partially on one or more QC parameters;
c. generating a QC report, wherein the QC report includes error statistics pertaining to at least one check performed at step b on the contact list;
d. generating an exceptions report based on the QC report and the one or more QC parameters; and
e. modifying the one or more QC parameters based on the exceptions report.

2. The method according to claim 1, wherein the method further comprises generating a counts and suppression report, which includes details of suppressions applied for generation of the contact list.

3. The method according to claim 1, wherein performing the output file check comprises verifying that the layout of various data values in the contact list conforms to a pre-determined layout.

4. The method according to claim 1, wherein performing the counts verification check comprises verifying the file counts at each stage of the processing.

5. The method according to claim 1, wherein performing the criteria outlier check comprises verifying that the contact list conforms to one or more of campaign criteria and privacy preferences.

6. The method according to claim 1, further comprising removing at least one customer profile from the contact list if the customer profile fails one or more of the criteria outlier check, the data values check, and the output file check.

7. A system for performing quality checks (QC) on a contact list for a direct marketing campaign, the system comprising:
a processor; and
a memory in communication with the processor, the memory storing a plurality of processing instructions for directing the processor to:
a. receive the contact list, wherein the contact list comprises a plurality of customer profiles;
b. perform at least one of a counts verification check, a criteria outlier check, a data values check, and an output file check on the contact list based at least partially on one or more QC parameters;
c. generate a QC report, wherein the QC report includes error statistics pertaining to at least one check performed at step b on the contact list;
d. generate an exceptions report based on the QC report and the one or more QC parameters; and
e. modify the QC parameters based on the exceptions report.

8. The system according to claim 7, wherein the instructions further comprise generating a counts and suppression report, which includes details of suppressions applied for generation of the contact list.

9. The system according to claim 7, wherein the instructions for carrying out the output file check comprise instructions for verifying that the layout of various data values in the contact list conforms to a predetermined layout.

10. The system according to claim 7, wherein the instructions for performing a counts verification check comprise instructions for verifying the file counts at each stage of the processing.

11. The system according to claim 7, wherein the instructions for performing a criteria outlier check comprise instructions for verifying that the contact list conforms to one or more of a campaign criteria and privacy preferences.

12. A computer program product for performing quality checks (QC) on a contact list for a direct marketing campaign, the computer program product comprising a computer readable storage medium having control logic stored therein, the control logic comprising:
a. first computer readable program code that causes the computer to receive the contact list, wherein the contact list comprises a plurality of customer profiles;
b. second computer readable program code that causes the computer to perform at least one of a counts verification check, a criteria outlier check, a data values check, and an output file check on the contact list based at least partially on one or more QC parameters;
c. third computer readable program code that causes the computer to generate a QC report, wherein the QC report includes error statistics pertaining to at least one check performed at step b on the contact list; and
d. fourth computer readable program code that causes the computer to generate an exceptions report based on the QC report and the one or more QC parameters.

13. The computer program product according to claim 12, wherein the computer readable program code further comprises:
sixth readable program code that causes the computer to generate a counts and suppression report, which includes details of suppressions applied for generation of the contact list.

14. The computer program product of claim 12, wherein performing the output file check comprises verifying that the layout of various data values in the contact list conforms to a pre-determined layout.

15. The computer program product of claim 12, wherein performing the criteria outlier check comprises verifying that the contact list conforms to one or more of campaign criteria and privacy preferences.
